(19) United States
(12) Patent Application Publication
(10) Pub. No.: US 2004/0119964 A1
(43) Pub. Date: Jun. 24, 2004

(54) Double isolation fine stage

(75) Inventors: Alex Ka Tim Poon, San Ramon, CA (US); Leonard Wai Fung Kho, San Francisco, CA (US); Pai-Hsueh Yang, Palo Alto, CA (US); Ping-Wei Chang, San Jose, CA (US)

Correspondence Address: BEYER WEAVER & THOMAS LLP, P.O. BOX 778, BERKELEY, CA, 94704-0778, US

(73) Assignee: Nikon Corporation

(21) Appl. No.: 10/325,391

(22) Filed: Dec. 18, 2002

(51) Int. Cl. G03B 27/58

(52) U.S. Cl. 355/72; 355/76; 355/75; 355/53; 310/10; 318/625

(57) ABSTRACT

A vibration isolation system is provided. A frame is provided. A stage supported by the frame is provided. The stage comprises a stage body supported by the frame, a first isolation stage supported by the stage body, a first stage vibration isolation device that reduces vibrations transferred from the stage body to the first isolation stage, a second isolation stage supported by the first isolation stage, and a second stage vibration isolation device that reduces vibrations transferred from the first isolation stage to the second isolation stage.

### BACKGROUND OF THE INVENTION

The invention relates to low vibration transmissibility fine stages. More specifically, the invention relates to low vibration transmissibility fine stages in lithography systems.

### BACKGROUND OF THE INVENTION

Exposure apparatuses are commonly used to transfer images from a reticle to a semiconductor wafer during semiconductor processing. A typical exposure apparatus may include an illumination source, a reticle stage assembly that retains a reticle, a lens assembly and a wafer stage assembly for supporting a semiconductor wafer.

Typically, the wafer stage assembly includes a wafer table that retains a semiconductor wafer and a wafer stage mover assembly that precisely positions the wafer table and the wafer. The wafer stage assembly may include a table mover assembly that moves the wafer table. Similarly, the reticle stage assembly includes a reticle stage for supporting a reticle and a reticle stage mover assembly that precisely positions the reticle stage and the reticle. The size of the images transferred onto the wafer from the reticle is extremely small. Accordingly, the precise relative positioning of the wafer and the reticle is critical to the manufacturing of high density semiconductor wafers.

The wafer stage mover assembly and the table mover may generate a reaction force and disturbances that may vibrate the wafer stage base and the apparatus frame. The vibrations may influence the position of the wafer table, and the wafer. As a result, the vibration may cause an alignment error between the reticle and the wafer. This may reduce the accuracy of the positioning of the wafer relative to the reticle and may degrade the accuracy of the exposure apparatus.

It is desirable to provide a stage assembly that precisely positions a device and reduces vibrations.

### SUMMARY OF THE INVENTION

To achieve the foregoing and in accordance with the purpose of the present invention, a vibration isolation system is provided. A frame is provided. A stage supported by the frame is provided. The stage comprises a stage body supported by the frame, a first isolation stage supported by the stage body, a first stage vibration isolation device that reduces vibrations transferred from the stage body to the first isolation stage, a second isolation stage supported by the first isolation stage, and a second stage vibration isolation device that reduces vibrations transferred from the first isolation stage to the second isolation stage.

In an alternative embodiment, a lithography system is provided. The lithography system comprises an illumination system that irradiates radiant energy, a reticle stage arranged to retain a reticle where the reticle stage carries the reticle disposed on a path of the radiant energy, and a working stage arranged to retain a workpiece where the working stage carries the workpiece disposed on a path of the radiant energy. The working stage comprises a stage body, a first isolation stage supported by the stage body, a first stage vibration isolation device that reduces vibrations transferred from the stage body to the first isolation stage, a second isolation stage supported by the first isolation stage, and a second stage vibration isolation device that reduces vibrations transferred from the first isolation stage to the second isolation stage.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic view of a lithographic system that uses an embodiment of the invention in a parallel active vibration isolation system.

FIG. 2 is a detailed cross-sectional view of an embodiment of the invention.

FIG. 3 is a flow chart of a semiconductor fabrication process using the embodiment of the invention.

FIG. 4 is a more detailed flow chart using the embodiment of the invention.

FIG. 5 is a top view of another embodiment of the invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

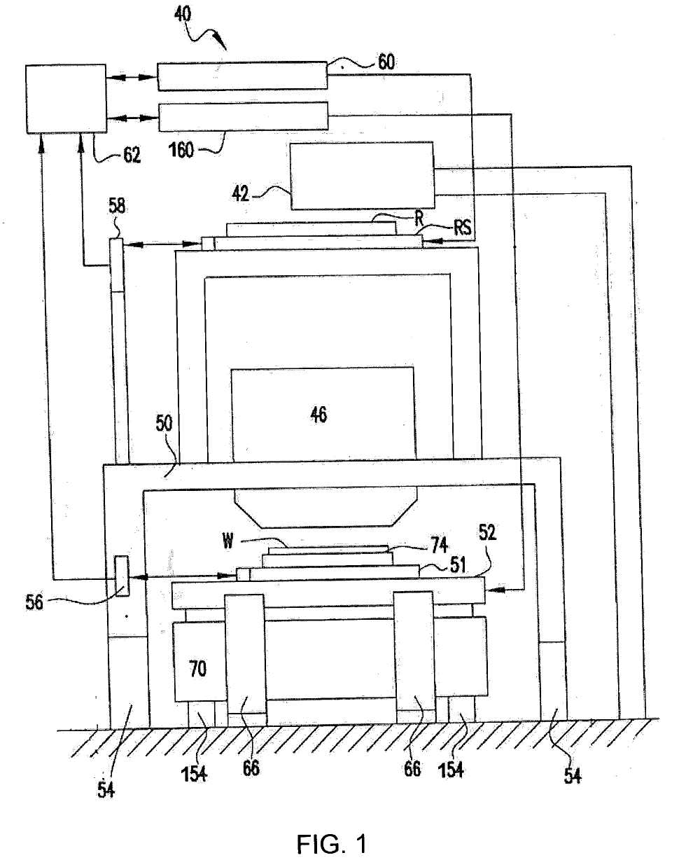

To facilitate understanding, FIG. 1 is an exemplary lithographic exposure that incorporates the present invention in a parallel active vibration isolation system. Such an exposure apparatus 40 may include a first part of a parallel active vibration isolation system 54, a second part of the parallel active vibration isolation system 154, a lens body 50 mounted on a first part of the parallel active vibration isolation system 54, a projection lens 46 mounted on the lens body 50, a reticle stage RS mounted on the lens body 50, a reticle R mounted on the reticle stage RS, a reticle stage interferometer 58 mounted on the lens body 50, a wafer position stage support device 70 mounted on a second part of the parallel active vibration isolation system 154, a wafer stage 52 mounted on the wafer position stage support base 70, a wafer table 51 mounted on the wafer stage 52, a wafer chuck 74 mounted on the wafer table 51, a wafer W mounted on the wafer chuck 74, a wafer stage reaction canceling assembly (ex. reaction frame assembly or counter mass assembly) 66, a system controller 62, a wafer stage interferometer 56 mounted on the lens body 50, a reticle stage drive control unit 60 connected to the system controller 62, a wafer stage drive control unit 160 connected to the system controller 62 and an illumination system 42 that irradiates radiant energy toward the reticle R and adjacent to the reticle R. The reticle stage interferometer 58 and the wafer stage interferometer 56 are connected to the system controller 62.

The reticle R is supported on the reticle stage RS. The reticle stage RS is supported by the lens body 50, which also supports the projection lens 46. The lens body 50 is supported by the first part of the active vibration isolation system 54, which vibrationally isolates the lens body 50 from the ground. The wafer W is supported on the wafer chuck 74, which is supported by the wafer table 51. The wafer table 51 is supported by the wafer stage 52, which is supported by the wafer position stage support base 70. The wafer stage support base 70 is supported by the second part of the active vibration isolation system 154, which vibrationally isolates the wafer from the ground. Since the wafer position stage support base 70 is isolated from ground independently from the lens body 50 parallel isolation is provided. Such parallel isolation allows the isolation to be decoupled providing for less cross interference caused by vibrations from the separate parts. Measurement devices such as interferometers 56 and 58 monitor the positions of the wafer table 51 and reticle stage RS, respectively, relative to a reference and outputs position data to the system controller 62. The projection lens 46 may include a lens assembly that projects and/or focuses the light or beam from an illumination system 42 that passes through the reticle R. The reticle stage RS is attached to a reticle stage drive control unit 60 controlled by the system controller 62 to precisely position the reticle R relative to the projection lens 46 (or at least one of the wafer table 51 and the wafer W). Similarly, the wafer stage 52 connected to a wafer stage drive control unit 160 to precisely position the wafer W workpiece relative to the projection lens 46 (or at least one of the reticle stage RS and the reticle R).

As will be appreciated by those skilled in the art, there are a number of different types of photolithography devices. For example, exposure apparatus 40 can be used as a scanning type photolithography system, which exposes the pattern from reticle R onto wafer W with reticle R and wafer W moving synchronously. In a scanning type lithographic device, reticle R is moved perpendicular to an optical axis of lens assembly 46 by reticle stage RS and wafer W is moved perpendicular to an optical axis of lens assembly 46 by wafer stage 52. Scanning of reticle R and wafer W occurs while the reticle R and wafer W are moving synchronously.

Alternately, exposure apparatus 40 can be a step-and-repeat type photolithography system that exposes reticle R while reticle R and wafer W are stationary. In the step-and-repeat process, wafer W is in a constant position relative to reticle R and lens assembly 46 during the exposure of an individual field. Subsequently, between consecutive exposure steps, wafer W is consecutively moved by wafer stage 52 perpendicular to the optical axis of lens assembly 46 so that the next field of semiconductor wafer W is brought into position relative to lens assembly 46 and reticle R for exposure. Following this process, the images on reticle R are sequentially exposed onto the fields of wafer W so that the next field of semiconductor wafer W is brought into position relative to lens assembly 46 and reticle R.

However, the use of exposure apparatus 40 provided herein is not limited to a photolithography system for semiconductor manufacturing. Exposure apparatus 40, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

The illumination source (of illumination system 42) can be g-line (436 nm), i-line (365 nm), KrF excimer laser (248 nm), ArF excimer laser (193 nm), and F₂ laser (157 nm). Alternatively, the illumination source can also use charged particle beams such as x-ray and electron beam. For instance, in the case where an electron beam is used, thermionic emission type lanthanum hexaboride (LaB₆,) or tantalum (Ta) can be used as an electron gun. Furthermore, in the case where an electron beam is used, the structure could be such that either a mask is used or a pattern can be directly formed on a substrate without the use of a mask.

With respect to lens assembly 46, when far ultra-violet rays such as the excimer laser is used, glass materials such as quartz and fluorite that transmit far ultra-violet rays is preferably used. When the F₂ type laser or x-ray is used, lens assembly 46 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 also use a reflecting-refracting type of optical system incorporating a concave mirror, etc., but without a beam splitter, and can also be employed with this invention. The disclosures in the above-mentioned U.S. patent, as well as the Japan patent applications published in the Official Gazette for Laid-Open Patent Applications, are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces, which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference. Reaction forces may also be cancelled by counter mass systems, as described in U.S. Pat. No. 6,281,655B1, entitled “High Performance Stage Assembly”, which is incorporated herein by reference.

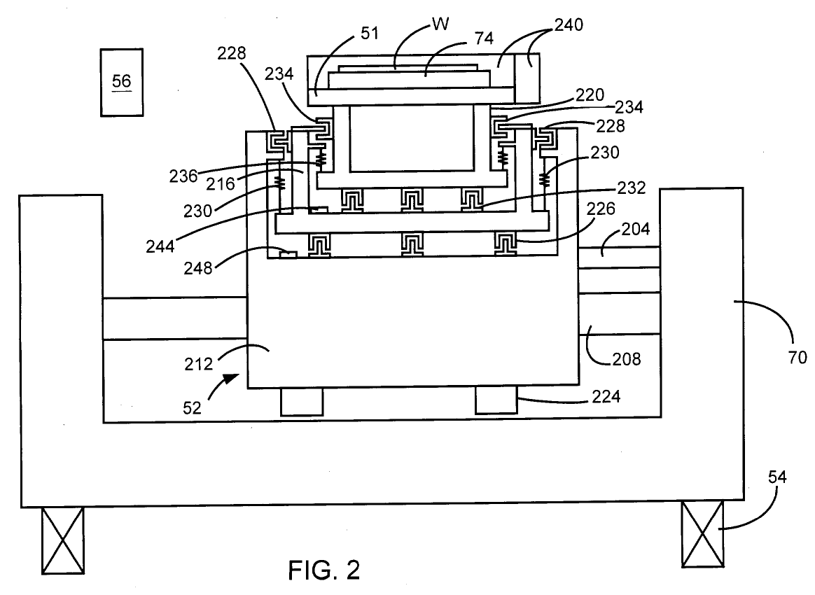

FIG. 2 is a more detailed cross-sectional view of the wafer stage 52 supported by the wafer position stage support base 70. A mover 204 may be connected between the wafer stage 52 and the support base 70 to provide movement of the wafer stage 52 along a rail (guide) 208 connected across the support base 70. The mover 204 may be controlled by the stage drive control unit 160. The wafer stage 52 comprises a wafer stage body 212, a first wafer isolation stage 216, and a second wafer isolation stage 220. A plurality of air bearings 224 are placed between the wafer stage body 212 and the wafer position stage support base 70 to provide at least one degree of freedom movement between the wafer stage body 212 and the support base 70. The support base 70 provides a frame for movement and support of the stage 52.

The wafer stage body 212 forms a cavity in which the first wafer isolation stage 216 is placed. A first plurality of voice coil actuators (voice coil motors: VCMs) 226 are placed between the bottom of the first wafer isolation stage 216 and the wafer stage body 212. A second plurality of voice coil actuators (voice coil motors: VCMs) 228 are placed between the sides of the first wafer isolation stage and the wafer stage body 212. A first plurality of springs 230 are also placed between the first wafer isolation stage 216 and the wafer stage body 212 along the Z axis. The first wafer isolation stage 216 forms a cavity in which the second wafer isolation stage 220 is placed. A third plurality of voice coil actuators 232 are placed between the bottom of the second wafer isolation stage 220 and the bottom of the cavity of the first wafer isolation stage 216. A fourth plurality of voice coil actuators 234 are placed between the sides of the second wafer isolation stage 220 and the sides of the cavity of the first wafer isolation stage 216. A second plurality of springs 236 are also placed between the first wafer isolation stage 216 and the second wafer isolation stage 220 along the Z axis. A first position detector 248 is placed between the stage body 212 and the first wafer isolation stage 216. A second position detector 244 is placed between the first wafer isolation stage 216 and the second wafer isolation stage 220. The position detectors 244, 248 may be optical encoders, capacitance sensors, or other measurement devices and may measure the relative position of objects for one to six degrees of freedom (x, y, z, θx, θy, θz). Preferably such devices do not need physical contact. Preferably, both the first position detector 248 and the second position detector 244 are six axis position readers, and are capable of measuring x, y, z, θx, θy, θz distances between the stage body 212 and the first wafer isolation stage 216 and between the first wafer isolation stage 216 and the second wafer isolation stage 220, respectively. Other devices may be used to measure the relative positions of the isolation stages 216, 220 and the stage body 212, without being placed between the isolations stages 216, 220 or the stage body 212. More generally, the position detectors 244, 248 or other devices may make up a position device that measures the relative positions between the stage body 212, the first isolation state 216, and the second isolation stage 220.

The wafer table 51 is mounted to the second wafer isolation stage 220. The wafer chuck 74 is mounted on the wafer table 51. A wafer W is mounted on the wafer chuck 74. A plurality of positioning mirrors 240 are mounted to the wafer table 51.

In operation, during an above-described scanning, the mover 204 moves the wafer stage 52 along the rail 208 to provide a scanning movement. The measurement system (wafer stage interferometer) 56 connected to the lens body 50, may reflect multiple light beams off of the positioning mirrors 240 to determine the position of the wafer W with respect to the projection lens assembly focus plane. The first plurality of voice coil actuators 226 are able to controllably move parts or all of the first wafer isolation stage 216 upwardly in the Z-direction. As a result, the first plurality of voice coil actuators 226 provide movement in the Z-direction and around a axis in the Y-direction and an axis in the X-direction, giving the first wafer isolation stage 216 three degrees of freedom. In a specific example, the first plurality of voice coil actuators 226 are three voice coil actuators arranged in a triangular pattern to provide the desired three degrees of freedom. The first plurality of springs 230 help to reduce the force of the weight applied to the first plurality of voice coil actuators 226. The second plurality of voice coil actuators 228 are placed in the X and Y directions so that they are able to move parts of the first wafer isolation stage 216 in the X-direction and Y-direction providing movement along the X-direction, Y-direction, and about the Z axis, giving the first wafer isolation stage 216 three degrees of freedom. As a result, the first wafer isolation stage 216 has six degrees of freedom. The desired position of the first wafer isolation stage 216 is to maintain relative fixed distance to the second wafer isolation stage 220. The position of the first wafer isolation stage 216 is determined by the information supplied by the second position encoder 244.

The third plurality of voice coil actuators 232 are able to controllably move parts or all of the second wafer isolation stage 220 upwardly in the Z-direction. As a result, the third plurality of voice coil actuators 232 provide movement in the Z-direction and around a axis in the Y-direction and an axis in the X-direction, giving the second wafer isolation stage 220 three degrees of freedom. In a specific example, the third plurality of voice coil actuators 232 are three voice coil actuators arranged in a triangular pattern to provide the desired three degrees of freedom. The second plurality of springs 236 help to reduce the force of the weight applied to the third plurality of voice coil actuators 232. The fourth plurality of voice coil actuators 234 are placed in the X and Y directions so that they are able to move parts of the second wafer isolation stage 220 in the X-direction and Y-direction providing movement along the X-direction, Y-direction, and about the Z axis, giving the second wafer isolation stage 220 three degrees of freedom. As a result, the second wafer isolation stage 220 has six degrees of freedom. The desired position of the second wafer isolation stage 220 is controlled and followed a reference move trajectory curve with respect to the projection lens assembly.

The measurement system 56 is able to determine the position of the wafer W and send a signal including information related to the determined position to the system controller 62 (FIG. 1). The first position detector 248 measures the distances between the stage body 212 and the first wafer isolation stage 216 and sends a signal including information related to the measured distances to the system controller 62. The second position detector 244 measures the distances between the first wafer isolation stage 216 and the second wafer isolation stage 220 and sends a signal including information related to the measured distances to the system controller 62. The system controller 62 compares measured distances with desired distances and sends a signal to the voice coil actuators which move the wafer table 51 until the wafer W is in a desired position. The desired position of the first wafer isolation stage 216 is to maintain a relative fixed distance to the second wafer isolation stage 220 at least one degree of freedom at all times which is determined by the information from the measurement system 56 and the second position encoder 244. The desired position of the stage body 212 is to maintain a relative fixed distance to the second wafer isolation stage 220 at least one degree of freedom at all times which is determined by the information from the measurement system 56, the second position encoder 244 and the first position encoder 248. The voice coil motors are able to provide some active vibration isolation. Since magnetic fields are used to support the isolation stages, the amount of high frequency vibration transferred may be reduced.

As described above, a photolithography system according to the above-described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

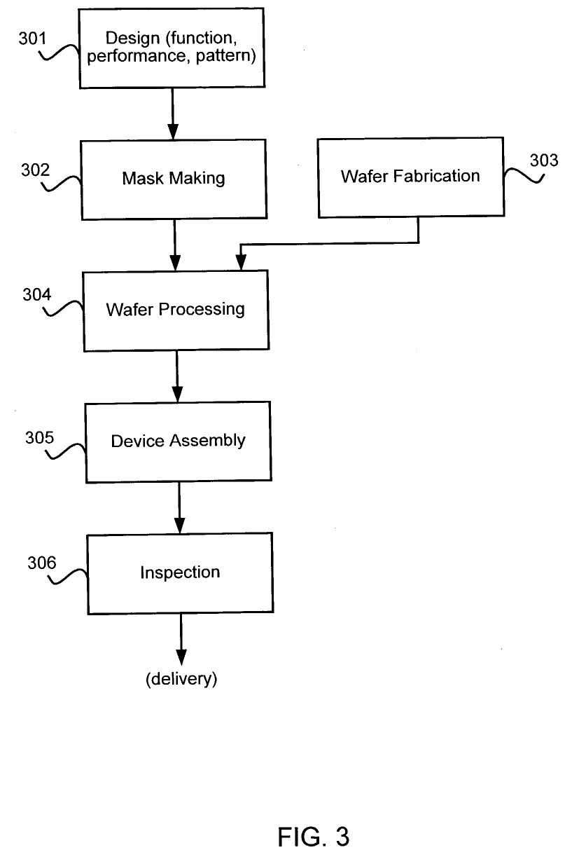

Further, semiconductor devices can be fabricated using the above-described systems, by the process shown generally in FIG. 3. In step 301, the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system, such as the systems (ex. combination of an electromagnet and a target) described above. In step 305, the semiconductor device is assembled (including the dicing process, bonding process and packaging process), then finally the device is inspected in step 306.

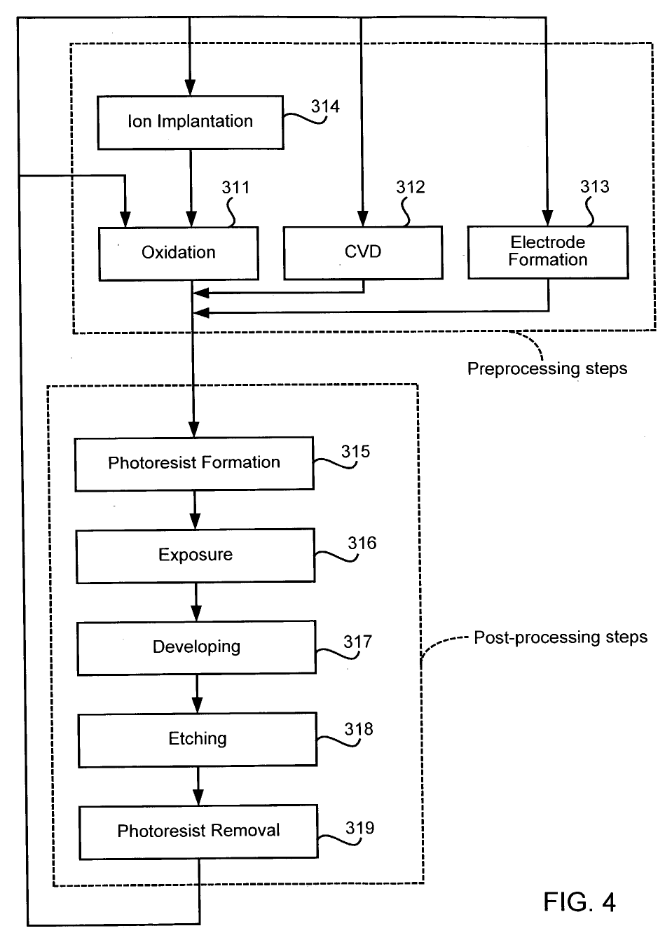

FIG. 4 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above-mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316 (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these preprocessing and post-processing steps.

A single stage isolation system may provide a damping of noise for −30 dB. Although the inventive double or multiple stage isolation system may have an increased component cost, such double or multiple stage isolation system in such an example may provide a damping of noise for −60 dB. Placing double isolation on a stage is able to remove a greater amount of vibration than a vibration isolation system for a large part of a system, because the smaller vibration isolation systems mounted on the stage are able to better dampen vibration, since a larger vibration isolation system supports a much larger mass and such systems typically are not able to dampen as much vibration for larger masses. The isolation systems on the stage are also able to better isolate the stage than the large vibration isolation system, since the center of mass of the large vibration isolation system is constantly moving with respect to the movement of the stage during scanning, whereas such scanning movement does not move the center of mass of the stage with respect to the isolation systems on the stage.

Dual stage isolation systems may use one stage as a medium isolation stage and the other stage as a fine isolation stage, with the stage body being considered a coarse stage with movement along the rail 208. Such a coarse stage may have one or two degrees of freedom. One stage may only have three degrees of freedom, while the other stage may have six degrees of freedom. Such a configuration may result from a more critical X and Y accuracy and less critical Z accuracy. This may be accomplished by replacing the first plurality of voice coil actuators 226 with air bearings. The dual stages may also provide a double range of motion. In addition, both isolation stages are moved with the wafer stage allowing for better isolation at higher bandwidth.

Other electromagnetic systems may be used in place of the voice coil actuators using Lorentz Force. Other active or passive vibration isolation apparatus may be used in place of the voice coil actuators. In addition, other spring and damper systems may be used to provide isolation. In other embodiments the vibration isolation system which isolates the entire stage assembly, including the stage body, may be an active isolation system, where the stage assembly, which is moved during scanning, still has a dual stage active isolation system.

Although the double isolation stages are shown for a wafer stage, the double isolation may also be used for the reticle stage. Therefore, the generic terms such as a “first isolation stage” may apply to different kinds of first isolation stages, such as a first wafer isolation stage or a first reticle isolation stage.

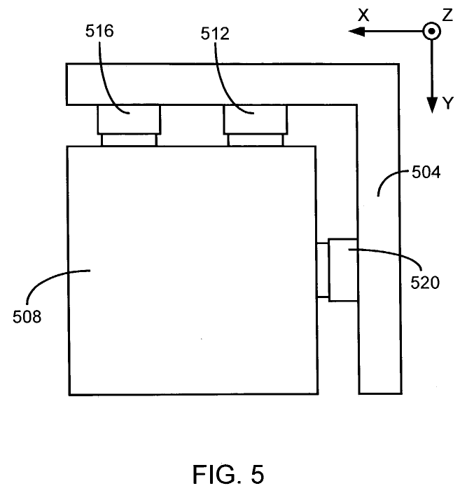

FIG. 5 is a top view of a first isolation stage 504 and a second isolation stage 508 used in another embodiment of the invention, which in this example may be isolation stages for a reticle. The part of the first isolation stage 504 that is shown in FIG. 5 has an L-shape flange. A first and a second voice coil actuator (voice coil motor: VCM) 512, 516 are mounted in the X-direction between the first isolation stage 504 and the second isolation stage 508. A third voice coil actuator (voice coil motor: VCM) 520 is mounted in the Y-direction between the first isolation stage 504 and the second isolation stage 508. This configuration provides movement in the X-direction, the Y-direction, and around the Z axis, since voice coil actuators are bi-directional. Therefore, this configuration provides three degrees of freedom.

While this invention has been described in terms of several preferred embodiments, there are alterations, permutations, and substitute equivalents which fall within the scope of this invention. It should also be noted that there are many alternative ways of implementing the methods and apparatuses of the present invention. It is therefore intended that the following appended claims be interpreted as including all such alterations, permutations, and substitute equivalents as fall within the true spirit and scope of the present invention.

What is claimed is:

1. A vibration isolation system, comprising:
a frame; and
a stage supported by the frame, comprising:
a stage body supported by the frame;
a first isolation stage supported by the stage body;
a first stage vibration isolation device that reduces vibrations transferred from the stage body to the first isolation stage;
a second isolation stage supported by the first isolation stage; and
a second stage vibration isolation device that reduces vibrations transferred from the first isolation stage to the second isolation stage.

2. The vibration isolation system, as recited in claim 1, further comprising an actuator that moves the stage body along a scanning path to provide a scanning.

3. The vibration isolation system, as recited in claim 2, wherein the second stage vibration isolation device provides six degrees of freedom.

4. The vibration isolation system, as recited in claim 3, wherein the stage further comprises a position detector that measures relative positions between the stage body, the first isolation stage, and the second isolation stage.

5. The vibration isolation system, as recited in claim 4, wherein the first stage vibration isolation device is an active vibration isolation system and wherein the second stage vibration isolation device is an active vibration isolation system.

6. The vibration isolation system, as recited in claim 5, further comprising a vibration isolation device supporting the stage body.

7. The vibration isolation system of claim 5, wherein the vibration isolation device supports the frame.

8. The vibration isolation system, as recited in claim 1, wherein the first stage isolation device comprises a plurality of actuators mounted between the first isolation stage and the stage body, and wherein the second stage isolation device comprises a plurality of actuators mounted between the first isolation stage and the second isolation stage.

9. A lithography system comprising:
an illumination system that irradiates radiant energy;
a reticle stage arranged to retain a reticle, the reticle stage carries the reticle disposed on a path of said radiant energy; and
a working stage arranged to retain a workpiece, the working stage carries the workpiece disposed on a path of said radiant energy, and comprising:
a stage body;
a first isolation stage supported by the stage body;
a first stage vibration isolation device that reduces vibrations transferred from the stage body to the first isolation stage;
a second isolation stage supported by the first isolation stage; and
a second stage vibration isolation device that reduces vibrations transferred from the first isolation stage to the second isolation stage.

10. The lithography system, as recited in claim 9, further comprising an actuator that moves the stage body along a scanning path to provide a scanning.

11. An object manufactured with the lithography system of claim 9.

12. A wafer on which an image has been formed by the lithography system of claim 9.

13. A method for making an object using a lithography process, wherein the lithography process utilizes a lithography system as recited in claim 9.

14. A method for patterning a wafer using a lithography process, wherein the lithography process utilizes a lithography system as recited in claim 9.
